(19) United States
(12) Patent Application Publication
(10) Pub. No.: US 2005/0096974 A1
(43) Pub. Date: May 5, 2005

(54) Method and apparatus for optimizing parking situations

(75) Inventors: Bryan Christopher Chagoly, Austin, TX (US); Dustin C. Kirkland, Austin, TX (US); David Bruce Kumhyr, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/697,918

(22) Filed: Oct. 30, 2003

(51) Int. Cl. G06F 17/60

(52) U.S. Cl. 705/13

(57) ABSTRACT

A parking management system is provided for optimizing parking situations based on preferences of individual drivers. A surveyor collects parking information, which identifies whether or not parking spaces are occupied by a vehicle. Parking information may be collected by sensors located near or within the parking spaces themselves. The parking information is stored in a parking data structure, such as a database, which also stores properties for the spaces. A profile data structure, such as a database, contains profiles for users of the parking structure. The parking management system identifies a user and retrieves the profile of the user from the profile data structure. The parking management system then searches the parking data structure for available spots and selects a spot or set of spots that most closely match the user's preferences. The parking management system then presents the spot of set of spots to the driver.

### BACKGROUND OF THE INVENTION

1. Technical Field

The present invention relates to monitoring parking availability and, in particular, to optimizing parking situations. Still more particularly, the present invention provides a method, apparatus, and program for optimizing parking situations based on user preferences.

2. Description of Related Art

Large parking lots and garages represent daily challenges for millions of people. Complicated parking structures can be found around the world at airports, sporting events, even at the beginning and/or end of a daily commute to work. These parking situations can be even more challenging for people with special needs, such as people with physical disabilities. And for people conducting business, such as loading or unloading goods, or simply business people on the run, time is precious and much time can be spent in parking lots searching for an optimal parking spot.

In both lots and garages, drivers can spend a great deal of time searching for a parking space that minimizes walking distance, protects a vehicle from damage, or meets other specific needs. Prior art solutions provide indications of parking availability or even guidance to locate an available spot. However, these solutions do not take into account the particular needs of the driver. Furthermore, many prior art solutions require special devices to be placed in a vehicle, which are expensive to implement for such a specialized task.

### SUMMARY OF THE INVENTION

The present invention recognizes the disadvantages of the prior art and provides a parking management system for optimizing parking situations based on preferences of individual drivers.

A surveyor collects parking information, which identifies whether or not parking spaces are occupied by a vehicle. Parking information may be collected by sensors located near or within the parking spaces themselves. The parking information is stored in a parking data structure, such as a database, which also stores properties for the spaces. Properties may include, for example, whether the space is a handicapped space, whether the space has a pole on one side or the other, whether the space is for compact cars, distance from an elevator, entrance, or exit, etc.

A profile data structure, such as a database, contains profiles for users of the parking structure. A profile may include the size of the parking space desired in case the user drives a particularly large or small vehicle. The profile may also contain specific requirements or preferences, such as being on an end of a row, whether a pole is on one side or another, and distance from elevator, for example. Any number of possibilities exists based on the known properties of the parking spaces. A default profile may be used for users without a profile in the data structure.

The parking management system of the present invention makes an intelligent recommendation for a parking spot. The parking management system identifies a user and retrieves the profile of the user from the profile data structure. The parking management system then searches the parking data structure for available spots and selects a spot or set of spots that most closely match the user's preferences. The parking management system then presents the spot or set of spots to the driver.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts an example parking structure in which the present invention may be implemented;

FIG. 2 is a block diagram illustrating a parking optimization system in accordance with a preferred embodiment of the present invention;

FIG. 3 is a block diagram illustrating a data processing system in which the present invention may be implemented;

FIG. 4 is an exemplary functional block diagram of a parking management system in accordance with a preferred embodiment of the present invention;

FIG. 5 is an exemplary functional block diagram of a terminal in accordance with a preferred embodiment of the present invention;

FIG. 6 illustrates an example parking database in accordance with a preferred embodiment of the present invention;

FIG. 7 depicts an example user profile in accordance with a preferred embodiment of the present invention;

FIG. 8 depicts an example output from the parking management system of the present invention; and

FIG. 9 is a flowchart illustrating the operation of a parking management system in accordance with a preferred embodiment of the present invention.

### DETAILED DESCRIPTION OF THE PREFERRED EMBODIMENT

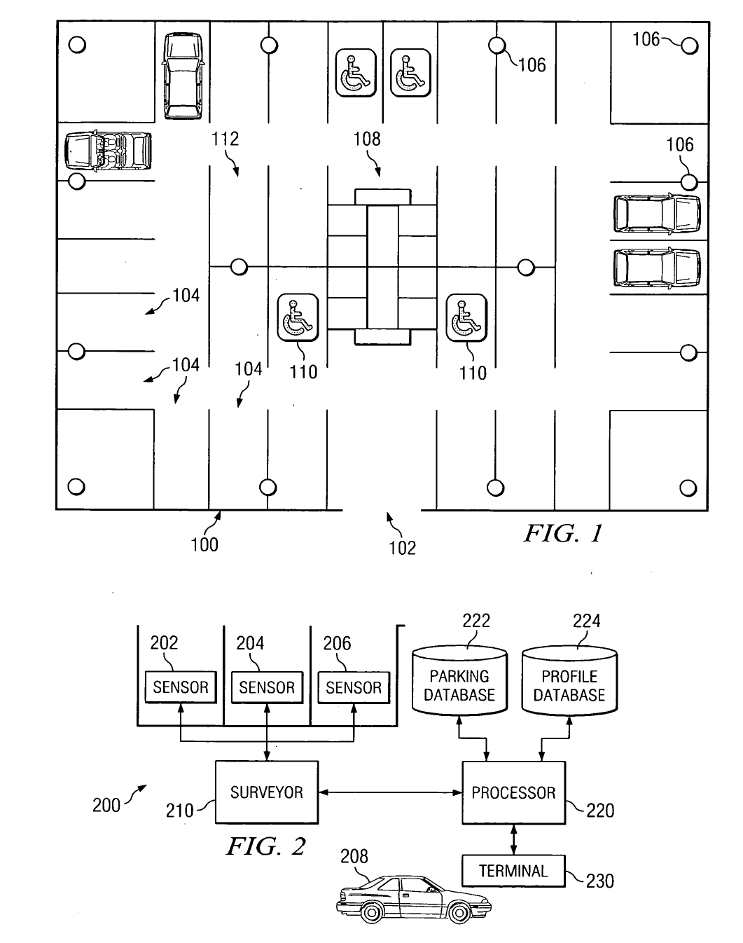

With reference now to the figures, FIG. 1 depicts an example parking structure in which the present invention may be implemented. In the depicted example, parking structure 100 is a parking garage or a level of a parking garage. Vehicles enter and exit the parking structure through entrance/exit 102 and may be parked in parking spaces, such as spaces 104. The parking structure may also include an elevator lobby 108. Drivers may select a parking space based upon several preferences. For example, a driver may wish to park a predetermined distance from entrance/exit 102 or elevator lobby 108.

The structure may include support poles, such as poles 106, which may encroach upon one or more parking spaces. Drivers may wish to park in a space with no poles. Alternatively, a driver may wish to park in a space with a pole on a particular side. For example, a driver may pull into a parking space forward with a pole on the right to reduce the likelihood that a driver's side door of a vehicle in an adjacent space will be opened into the side of vehicle.

Parking structure 100 may also include specially designated spaces. For example, spaces 110 may be designated for handicapped parking. As another example, space 112 may be designated for compact cars only. Other parking space designations and properties may also be recognized by a person of ordinary skill in the art.

In accordance with a preferred embodiment of the present invention, a parking management system is provided for optimizing parking situations based on preferences of individual drivers. Sensors may be provided to indicate whether spaces are occupied by a vehicle. Parking availability information, as well as properties and designations for each space, is stored in a parking information data structure. Drivers provide profile information including parking preferences. Each driver may be uniquely identified using, for example, a magnetic stripe card, bar code, smart card, or the like. When a driver enters the parking structure, the driver is identified and a parking space is selected based on the driver's individual profile. The selected space or set of spaces are presented to the driver.

FIG. 2 is a block diagram illustrating a parking optimization system in accordance with a preferred embodiment of the present invention. Sensors 202, 204, 206 determine whether or not a vehicle is parked in a parking space. The sensors may sense the weight of the vehicle. Alternatively, a light emitting diode (LED) and a sensor may detect reflected light. A heat sensor may detect the heat of a recently running automobile. A digital camera may perform image processing techniques to determine parking spots that are occupied by a vehicle. Other sensor mechanisms may also be used within the scope of the present invention.

Surveyor 210 receives parking space occupancy information from sensors 202, 204, 206 and provides the parking space occupancy information to processor 220 to be stored in parking database 222. The parking database also stores properties for the spaces. Properties may include, for example, whether the space is a handicapped space, whether the space has a pole on one side or the other, whether the space is for compact cars, distance from an elevator, entrance, or exit, etc. A camera may even detect the license plate information to be stored in association with occupied parking spaces.

Profile database 224 contains profiles for users of the parking structure. A profile may include the size of the parking space desired in case the user drives a particularly large or small vehicle. The profile may also contain specific requirements or preferences, such as being on an end of a row, whether a pole is on one side or another, and distance from elevator, for example. Any number of possibilities exists based on the known properties of the parking spaces. A default profile may be used for users without a profile in the data structure.

The parking management system of the present invention makes an intelligent recommendation for a parking spot. When a vehicle, such as automobile 208, approaches terminal 230, the driver provides identification information. The driver may be identified using, for example, a magnetic stripe card, a smart card, a bar code, or the like. The terminal provides the identification information to processor 220. After the user is identified, the processor retrieves the profile of the user from profile database 224. The parking management system then searches parking database 222 for available spots and selects a spot or set of spots that most closely match preferences in the user's profile. Matching parking spaces may be selected using known fuzzy logic methodologies. Spaces may be assigned rankings or ratings based upon how closely they match the user profile. Terminal 230 then presents the spot of set of spots to the driver.

Terminal may be a simple keypad and display. However, the terminal may vary depending upon the implementation. For example, terminal 230 may be a touch screen or microphone/speaker combination. In an exemplary embodiment of the present invention, terminal 230 is a separate device with a controller and a communications interface for communication with processor 220.

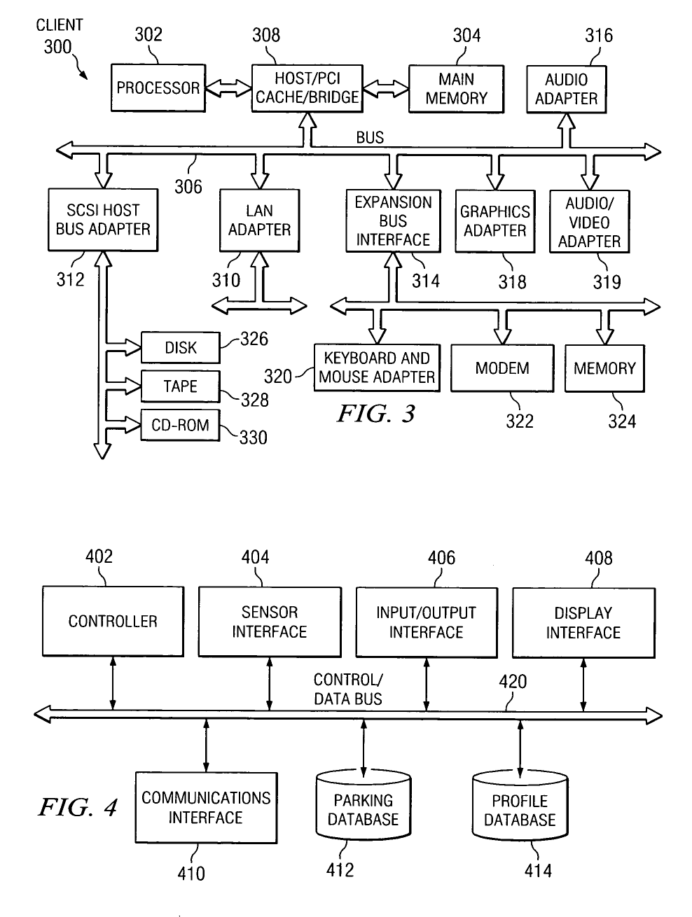

With reference now to FIG. 3, a block diagram illustrating a data processing system is depicted in which the present invention may be implemented. Data processing system 300 is an example of a processing system that may be implemented as processor 220 in FIG. 2. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. The depicted example in FIG. 3 and above-described examples are not meant to imply architectural limitations. Data processing system 300 also may be a kiosk or a Web appliance.

FIG. 4 is an exemplary functional block diagram of a parking management system in accordance with a preferred embodiment of the present invention. The elements of the functional block diagram of FIG. 4 may be implemented as hardware, software, or a combination of hardware and software components. In a preferred embodiment, the functional elements shown in FIG. 4 are implemented as software instructions executed by one or more of the hardware elements shown in FIG. 3.

As shown in FIG. 4, the parking management system includes a controller 402, a sensor interface 404, an input/output interface 406, display interface 408, and communications interface 410. These elements are in communication with one another via the control/data bus 420. Although a bus architecture is shown in FIG. 4, the present invention is not limited to such and any architecture allowing for the communication of control messages and data between the elements 402-410 may be used without departing from the spirit and scope of the present invention.

Controller 402 controls the overall operation of the parking management system. The controller may receive input from the terminal via the communications interface 410 and sends requests for user profiles to profile database 414. The controller receives the parking information from parking database 412 and selects one or more parking spaces that best match preferences in a user profile. Controller 402 then provides information about the selected space or spaces to the terminal via communications interface 410.

In addition, the controller 402 receives sensor data via the sensor interface 404 and stores the sensor data in parking database 412 in association with the individual parking spaces. Information in parking database 412 and profile database 414 may be added, updated, or deleted by an operator through communications interface 410 or through input/output interface 406. For example, a mouse and keyboard may be connected to input/output interface 406 and a user interface may be presented through display interface 408.

Controller 402 makes an intelligent recommendation for a parking spot. The controller identifies the user and retrieves the profile of the user from the profile data structure. The controller then searches the parking data structure for available spots and selects a spot or set of spots that most closely match the user's preferences. The controller then presents the spot of set of spots to the driver.

In an exemplary embodiment, controller 402 assigns a price to each selected parking spot based upon the rating. Thus, parking spots that are more desirable may be assigned a higher price. For example, in a parking lot for an amusement park or sporting event, parking spots that are closer to the event may yield a higher price. Users that require certain criteria may pay an extra price for a space that meets the criteria.

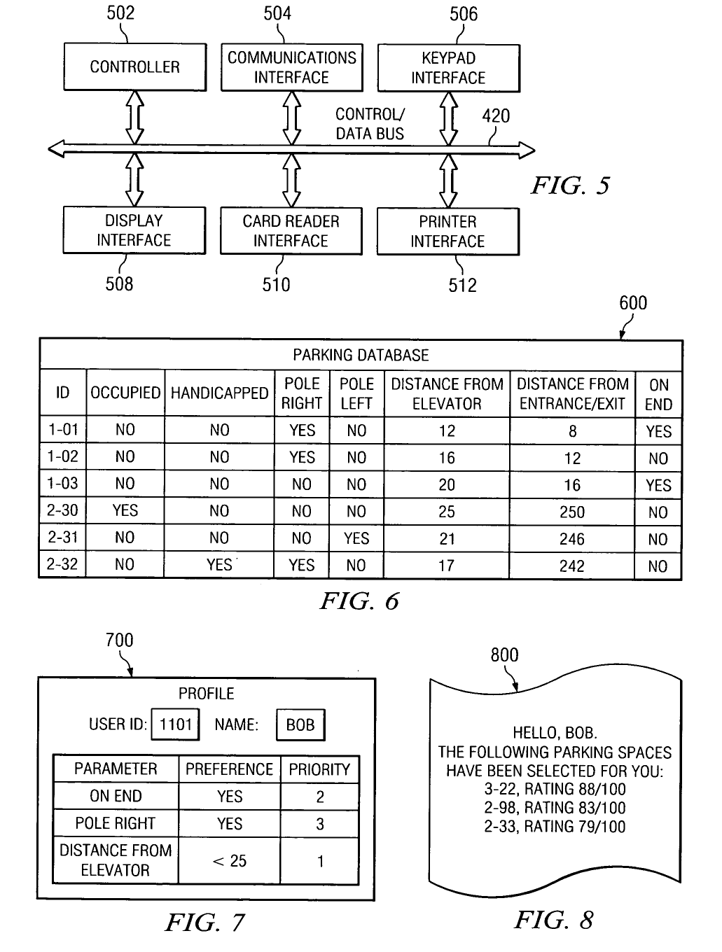

FIG. 5 is an exemplary functional block diagram of a terminal in accordance with a preferred embodiment of the present invention. The elements of the functional block diagram of FIG. 5 may be implemented as hardware, software, or a combination of hardware and software components.

As shown in FIG. 5, the terminal includes a controller 502, a communications interface 504, a keypad interface 506, display interface 508, card reader interface 510, and printer interface 512. These elements are in communication with one another via the control/data bus 520. Although a bus architecture is shown in FIG. 5, the present invention is not limited to such and any architecture allowing for the communication of control messages and data between the elements 502-512 may be used without departing from the spirit and scope of the present invention.

Controller 502 controls the overall operation of the terminal. The controller may receive input from the user via the keypad interface 506. For example, the user may enter an identification code using a keypad (not shown) and the controller may present this information to a data processing system via communications interface 504. Alternatively, the user may swipe or scan a card via card reader interface 510.

Many parking lots and garages require the use of an identification card or badge for admission. This identification information may be used to retrieve personalized profiles for frequent users. A card reader may be, for example, a magnetic stripe card reader, a bar code reader, or other card reader known in the art. A card may include identification information for the user. In an alternative exemplary embodiment, a user's card may store the user's profile. Other identification mechanisms, such as voice recognition, may also be used within the scope of the present invention. For example, a camera and image recognition software may be used to determine a license plate number, which may be associated with a particular user profile.

Controller 502 receives parking information, including one or more spaces that match the user's profile via communications interface 504. The controller may then present this information to the user via display interface 508. The parking information may identify a set of spaces and corresponding ratings. For example, a rating of 100 may indicate that a space matches the user's preferences exactly while a rating of 0 may indicate that a space does not match any of the user's preferences.

In an exemplary embodiment, the parking information may be presented via printer interface 512. Thus, the user may receive a hard copy of the parking information. The driver may then proceed to one of the selected parking spaces. A hard copy of the parking information may also include other useful information, such as directions to the parking space, parking rates, or coupons for discounts on goods or services.

FIG. 6 illustrates an example parking database in accordance with a preferred embodiment of the present invention. Parking database 600 includes a record or row for each parking space. Each record includes an identification (ID) and a plurality of properties and designations for a respective parking space. For example, parking space “1-01” is not designated as a handicapped space, has a pole on the right side of the space, does not have a pole on the left side of the space, is twelve feet from the elevator lobby, is eight feet from the entrance/exit, and is on the end.

Every space in the parking structure may be represented in the database. In a preferred embodiment, each record includes an indication of whether or not the space is occupied. In the example shown in FIG. 6, space “2-30” is occupied by a vehicle. The parking management system of the present invention may search parking database 600 for available parking spaces that sufficiently match a user's preferences.

FIG. 7 depicts an example user profile in accordance with a preferred embodiment of the present invention. Profile 700 includes a user identification, a user name, and a plurality of user preferences. In the depicted example, user ID “1101” refers to a user by the name of “Bob.” As shown in FIG. 7, Bob prefers a space on the end with a pole on the right and less than twenty-five feet from the elevator lobby. The preferences also include a priority, which may be weighted when selecting matching parking spaces. In this example, the distance from the elevator has the highest priority, while having a pole on the right of the parking space has the lowest priority.

Preferably, every user may be represented in the profile database; however, the profile database may include a default profile for users without a profile. In an exemplary embodiment, each profile includes a preference for every property and designation included in the parking database, although a user may provide values and priorities for only a subset of the properties and designations.

With reference now to FIG. 8, an example output from the parking management system of the present invention is shown. Output 800 is a printed output listing the three most closely matching available parking spaces with ratings. Since output 800 is a printed output, the user may receive a hard copy of the parking information and then proceed to one of the selected parking spaces. As stated above, output 800 may also include other useful information, such as directions to the parking space, parking rates, or coupons for discounts on goods or services.

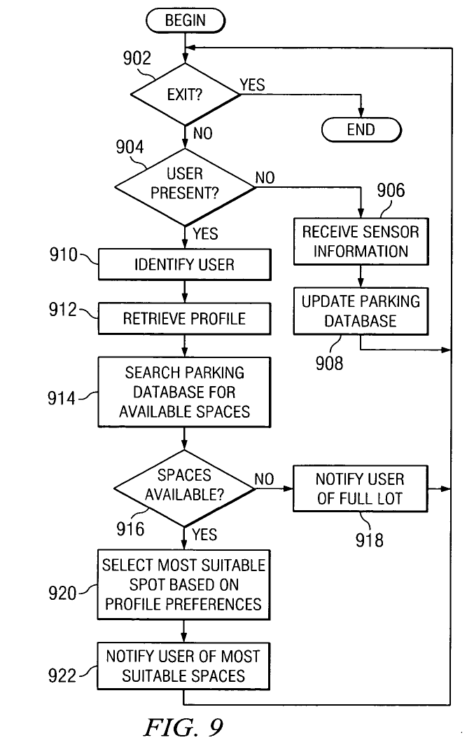

FIG. 9 is a flowchart illustrating the operation of a parking management system in accordance with a preferred embodiment of the present invention. The process begins and a determination is made as to whether an exit condition exists (step 902). If an exit condition exists, the process ends. An exit condition exist when the parking optimization device loses power or is shut down or when hours of parking availability have ended.

If an exit condition does not exist in step 902, a determination is made as to whether a user is present (step 904). The determination of whether a user is present may be made by sensing whether a vehicle is present at a terminal in a manner similar to detecting whether a parking space is occupied. Alternatively, the determination of whether a user is present may be made by determining whether a user swipes a card or depresses a key on a keypad.

If a user is not present, the process receives sensor information (step 906) and updates the parking database based on the sensor information (step 908). Thereafter, the process returns to step 902 to determine whether an exit condition exists.

If a user is present in step 904, the process identifies the user (step 910) and retrieves the user's profile (step 912). A default profile may be used for users without a profile in the data structure. Then, the process searches the parking database for available spaces (step 914) and a determination is made as to whether spaces are available (step 916). If no spaces are available, the process notifies the user that the lot is full (step 918) and returns to step 902 to determine whether an exit condition exists.

If spaces are available in step 916, the process selects the most suitable spots based on the user profile preferences (step 920). Suitable parking spaces may be selected using known fuzzy logic methodologies. Also, the matching parking spots may be ranked or rated to provide user with an indication of how closely the spots match the user's preferences. Then, the process notifies the user of the most suitable spaces (step 922) and returns to step 902 to determine whether an exit condition exists.

Thus, the present invention solves the disadvantages of the prior art by providing a parking management system for optimizing parking situations based on preferences of individual drivers. A surveyor collects parking information, which identifies whether or not parking spaces are occupied by a vehicle. Parking information may be collected by sensors located near or within the parking spaces themselves. The parking information is stored in a parking data structure, such as a database, which also stores properties for the spaces. A profile data structure, such as a database, contains profiles for users of the parking structure. The parking management system of the present invention makes an intelligent recommendation for a parking spot. The parking management system identifies a user and retrieves the profile of the user from the profile data structure. The parking management system then searches the parking data structure for available spots and selects a spot or set of spots that most closely match the user's preferences. The parking management system then presents the spot of set of spots to the driver.

Parking lots and garages that utilize the parking management system of the present invention provide a significant value-add over competitors lacking such technology. These parking structures may charge premium rates based on how premium a space is or how closely it matches the user's requested space. Such smart lots also provide significant advantages for individuals with special needs. Advantages are also available for users who are loading or unloading goods or users that may be willing to pay for better spots in such situations.

The present invention utilizes customized user profiles to make logical decisions as to which parking space would be most desired by the user. The present invention does not require that each vehicle maintain a transceiver or other such equipment that would require a significant buy-in by consumers.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for providing location data concerning optimal parking spaces according to a user profile, comprising the steps of:
providing a user profile containing data concerning preferred parking parameters to a parking space;
providing a parking database including data concerning parking parameters for each of a plurality of parking spaces under the control of a parking management system;
determining a list of available parking spaces; and
responsive to a user communication with the parking management system, providing an optimal available parking space based on the user profile, the parking database, and the list of available parking spaces.

2. The method of claim 1, wherein the user profile includes an identification of a user.

3. The method of claim 1, wherein the data concerning preferred parking parameters includes a set of parameters and, for each parameter within the set of parameters, a preference value and a priority.

4. The method of claim 1, wherein the user profile is a default profile.

5. The method of claim 1, wherein the user profile is selected responsive to receiving an identification of a user.

6. The method of claim 5, wherein the identification of the user is received by one of a card reader and a keypad interface.

7. The method of claim 1, wherein the parking parameters include at least one of an identification, an indication of whether a parking space is occupied, an indication of whether the parking space is designated as handicapped, an indication of whether a pole is on one side of the parking space, a distance from an elevator lobby, a distance from an entrance or exit, and an indicator of whether the parking space is on an end of a row.

8. The method of claim 1, wherein determining a list of available parking spaces includes receiving sensor information from a plurality of sensors, wherein each sensor within the plurality of sensors indicates whether a given parking space is occupied.

9. The method of claim 1, wherein providing an optimal available parking space includes outputting the optimal available parking space to an output device.

10. The method of claim 1, wherein output device is one of a display and a printer.

11. An apparatus for providing location data concerning optimal parking spaces according to a user profile, the apparatus comprising:
a parking management system;
a user profile containing data concerning preferred parking parameters to a parking space; and
a parking database including data concerning parking parameters for each of a plurality of parking spaces under the control of a parking management system,
wherein the parking management system determines a list of available parking spaces and, responsive to a user communication with the parking management system, provides an optimal available parking space based on the user profile, the parking database, and the list of available parking spaces.

12. The apparatus of claim 11, wherein the user profile includes an identification of a user.

13. The apparatus of claim 11, wherein the data concerning preferred parking parameters includes a set of parameters and, for each parameter within the set of parameters, a preference value and a priority.

14. The apparatus of claim 11, wherein the user profile is a default profile.

15. The apparatus of claim 11, wherein the user profile is selected responsive to receiving an identification of a user.

16. The apparatus of claim 15, wherein the identification of the user is received by one of a card reader and a keypad interface.

17. The apparatus of claim 11, wherein the parking parameters include at least one of an identification, an indication of whether a parking space is occupied, an indication of whether the parking space is designated as handicapped, an indication of whether a pole is on one side of the parking space, a distance from an elevator lobby, a distance from an entrance or exit, and an indicator of whether the parking space is on an end of a row.

18. The apparatus of claim 11, wherein the parking management system receives sensor information from a plurality of sensors, wherein each sensor within the plurality of sensors indicates whether a given parking space is occupied.

19. The apparatus of claim 11, wherein the parking management system outputs the optimal available parking space to an output device.

20. The apparatus of claim 11, wherein the output device is one of a display and a printer.

21. A computer program product, in a computer readable medium, for providing location data concerning optimal parking spaces according to a user profile, the computer program product comprising:
instructions for determining a list of available parking spaces; and
instructions, responsive to a user communication with a parking management system, for providing an optimal available parking space based on a user profile containing data concerning preferred parking parameters to a parking space, a parking database including data concerning parking parameters for each of a plurality of parking spaces under the control of a parking management system, and the list of available parking spaces.
